(19) United States
(12) Patent Application Publication
(10) Pub. No.: US 2019/0301410 A1
(43) Pub. Date: Oct. 3, 2019

(54) INTAKE PORT STRUCTURE

(71) Applicant: Honda Motor Co.,Ltd., Tokyo (JP)

(72) Inventor: Kenichiro IKEYA, Saitama (JP)

(73) Assignee: Honda Motor Co.,Ltd., Tokyo (JP)

(21) Appl. No.: 16/361,237

(22) Filed: Mar. 22, 2019

(30) Foreign Application Priority Data
Mar. 29, 2018 (JP) 2018-064940

(51) Int. Cl. F02M 35/10

(52) U.S. Cl. CPC F02M 35/10118; F02M 35/10314; F02M 35/10032

(57) ABSTRACT

An intake port structure has a sleeve disposed along an inner peripheral surface of an intake port of a cylinder head and made of a material having a thermal conductivity lower than a material of the cylinder head. When a cross-sectional area of an intake passage on an upstream side in an vicinity of a mating surface between the cylinder head and the intake passage toward the cylinder head is defined as a mating surface upstream area, and an intake port cross-sectional area of the intake port, which excludes the sleeve, on a downstream side in the vicinity is defined as a mating surface downstream area, the mating surface downstream area is greater than the mating surface upstream area, and the intake port cross-sectional area at a place where the sleeve is disposed in the intake port is gradually reduced from the mating surface toward a combustion chamber side.

### CROSS-REFERENCE TO RELATED APPLICATION

This application claims the priority benefit of Japan Application No. 2018-064940, filed on Mar. 29, 2018. The entirety of the above-mentioned patent application is hereby incorporated by reference herein and made a part of this specification.

### BACKGROUND

### Technical Field

The disclosure relates to an intake port structure having a sleeve with an insulating property in an intake port of a cylinder head of an engine.

### Description of Related Art

Conventionally, an intake device of an engine in which an intake port in a cylinder head of the engine is partitioned into two passages by a tumble plate and an intake upstream side of one of the passages is configured to be able to open and close by a valve is known (see, for example, Patent Document 1: Japanese Patent No. 4728195).

In the intake device, by closing one of the flow passages with a valve and allowing intake air to obliquely flow into the cylinder from the other passage, a tumble (longitudinal vortex) can be generated in a combustion chamber, and fuel consumption of the engine can be improved. In addition, by opening the valve and allowing the intake air to flow into the combustion chamber from the two passages, the amount of intake air as well as the output of the engine are increased.

Since the conventional tumble plate described in Patent Document 1 is directly attached to the inner wall surface of the intake port by fitting, etc., the conventional tumble plate receives heat from a high-temperature ceiling surface of the combustion chamber through the cylinder head. Accordingly, the heat transfer to the intake port increases and the temperature of the intake port rises. When the temperature of the intake port rises, a problem that the intake air filling efficiency deteriorates arises.

For this reason, the applicant of the disclosure has proposed to provide a sleeve with an insulating property on the inner peripheral surface of the intake port and attach a guide member to the sleeve to be supported in the intake port, thereby reducing the heat received by the guide member and suppressing the temperature rise of the intake port as compared to the conventional art (Japanese Patent Application No. 2016-206487).

However, in the case where such a sleeve is provided in the intake port, there is still issue to be solved from the viewpoint of assembling properties of the sleeve or from the viewpoint of setting a shape of the intake port which can satisfy the intake performance after the sleeve is provided.

### SUMMARY

An intake port structure according to an aspect of the disclosure has, in an intake port (e.g., an intake port 11 to be described later) of a cylinder head (e.g., a cylinder head 10 to be described later) of an engine (e.g., an engine 100 to be described later), a sleeve (a sleeve 30 to be described later) that is disposed along an inner peripheral surface (e.g., an inner peripheral surface 11c to be described later) of the intake port and made of a material having a thermal conductivity lower than a material of the cylinder head. When a cross-sectional area of an intake passage (e.g., an intake passage 24 to be described later), through which intake air flows toward the cylinder head, on an upstream side in an vicinity of a mating surface (e.g., a mating surface S to be described later) between the cylinder head and the intake passage is defined as a mating surface upstream area, and a cross-sectional area of the intake port, which excludes the sleeve, on a downstream side in the vicinity of the mating surface between the cylinder head and the intake passage is defined as a mating surface downstream area, the mating surface downstream area is greater than the mating surface upstream area, and the intake port cross-sectional area at a place where the sleeve is disposed in the intake port is gradually reduced from the mating surface toward a combustion chamber side.

### BRIEF DESCRIPTION OF THE DRAWINGS

FIG. 1 is an enlarged partial cross-sectional view of an intake port structure of an engine including a sleeve according to the disclosure.

FIG. 2 is a view observed along an arrow A in FIG. 1 and illustrates a sleeve provided in the intake port from an end surface side of a cylinder head.

FIG. 3 is an overall perspective view illustrating the sleeve and a guide member disposed in the intake port of the engine shown in FIG. 1.

FIG. 4 is a cross-sectional view of the intake port taken along a plane parallel to the guide member.

FIG. 5 is a graph showing a relationship between presence and absence of the sleeve at each position of the intake port and the cross-sectional area of the intake port.

FIG. 6 is a diagram showing a relationship between the sleeve as well as the guide member and an intake passage when a mating surface between the intake port having the sleeve and the intake passage is viewed from the intake port side.

### DESCRIPTION OF THE EMBODIMENTS

The disclosure provides an intake port structure in which the sleeve can be easily assembled into the intake port of the cylinder head and the shape of the intake port having the sleeve can be easily made into a desired shape.

An intake port structure according to an aspect of the disclosure has, in an intake port (e.g., an intake port 11 to be described later) of a cylinder head (e.g., a cylinder head 10 to be described later) of an engine (e.g., an engine 100 to be described later), a sleeve (a sleeve 30 to be described later) that is disposed along an inner peripheral surface (e.g., an inner peripheral surface 11c to be described later) of the intake port and made of a material having a thermal conductivity lower than a material of the cylinder head. When a cross-sectional area of an intake passage (e.g., an intake passage 24 to be described later), through which intake air flows toward the cylinder head, on an upstream side in an vicinity of a mating surface (e.g., a mating surface S to be described later) between the cylinder head and the intake passage is defined as a mating surface upstream area, and a cross-sectional area of the intake port, which excludes the sleeve, on a downstream side in the vicinity of the mating surface between the cylinder head and the intake passage is defined as a mating surface downstream area, the mating surface downstream area is greater than the mating surface upstream area, and the intake port cross-sectional area at a place where the sleeve is disposed in the intake port is gradually reduced from the mating surface toward a combustion chamber side.

According to one or some exemplary embodiments of the disclosure, the sleeve can be easily assembled into the intake port of the cylinder head, and the cross-sectional shape of the intake port of the inner peripheral surface of the sleeve can be easily made into a desired shape.

In the intake port structure according to one or some exemplary embodiments of the disclosure, a cross-sectional area of an inner peripheral surface of the sleeve is equal to or greater than the cross-sectional area of the intake passage.

According to one or some exemplary embodiments of the disclosure, the sleeve does not imposes a limitation when intake air flows in, and the sleeve does not result in a pressure loss of the intake air.

In the intake port structure according to one or some exemplary embodiments of the disclosure, the intake port cross-sectional area at the place where the sleeve is provided in the intake port has an amount of gradual reduction from the mating surface side to a predetermined position greater than an amount of gradual reduction from the predetermined position to the combustion chamber (e.g., a combustion chamber 20 to be described later) side.

According to one or some exemplary embodiments of the disclosure, the sleeve can be easily positioned along the axial direction of the intake port.

In the intake port structure according to one or some exemplary embodiments of the disclosure, on the mating surface, a position of the inner peripheral surface of the sleeve is disposed on an outer side with respect to a position of an inner peripheral surface (e.g., an inner peripheral surface 24a to be described later) of the intake passage in a radial direction.

According to one or some exemplary embodiments of the disclosure, the sleeve does not result in a pressure loss of the intake air, and the sleeve can be certainly positioned in the intake port. Also, the sleeve can be prevented from protruding inwardly in the radial direction with respect to the position of the inner peripheral surface of the intake passage even if an assembling variation occurs when the sleeve is assembled into the intake port.

According to the disclosure, an intake port structure in which the sleeve can be easily assembled into the intake port of the cylinder head and the shape of the intake port having the sleeve can be easily made into a desired shape is provided.

Hereinafter, embodiments of the disclosure will be described in detail with reference to the drawings.

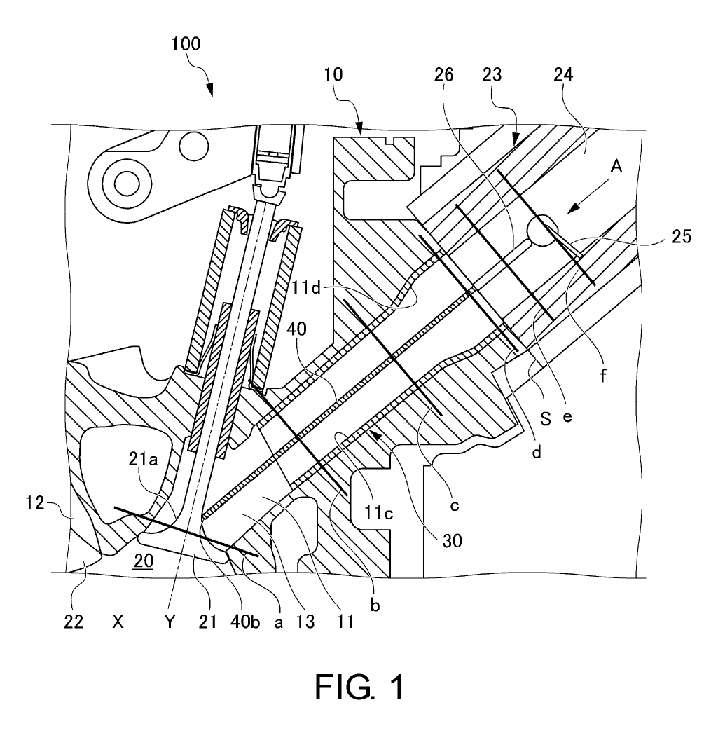

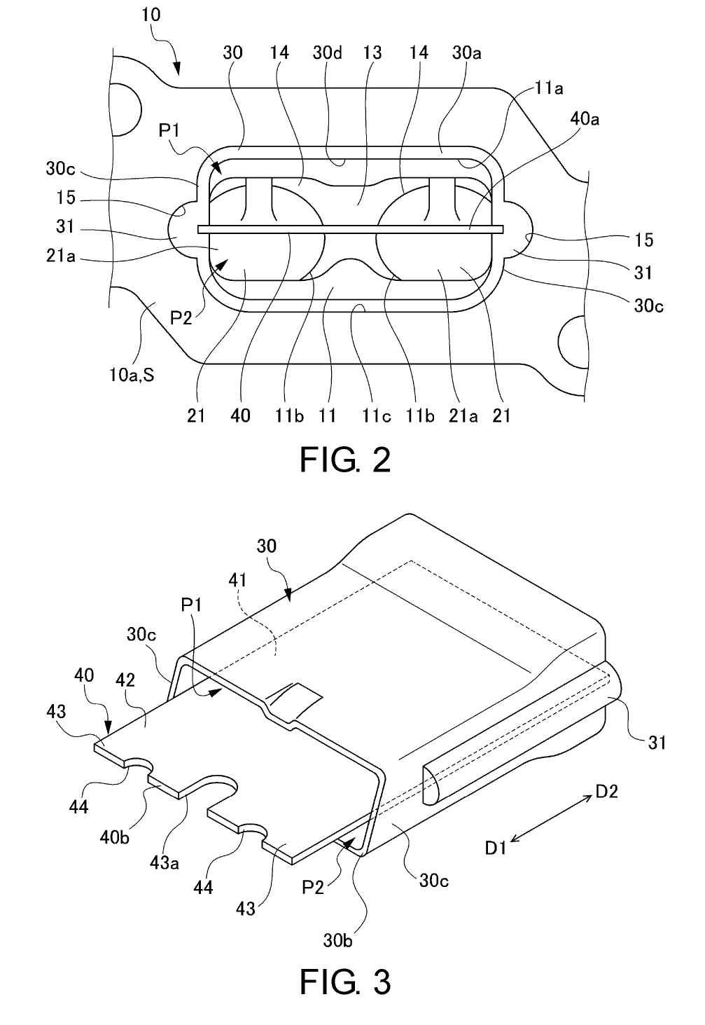

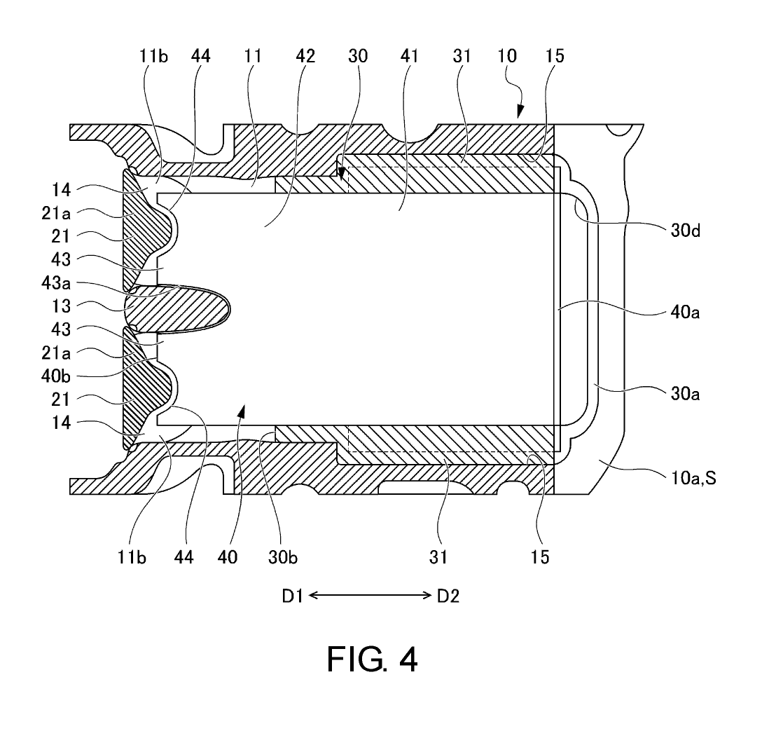

FIG. 1 is an enlarged partial cross-sectional view of the vicinity of an intake port of an engine including a guide member according to the disclosure. FIG. 2 is a view observed along an arrow A in FIG. 1 and illustrates a sleeve provided in the intake port from an end surface side of a cylinder head. FIG. 3 is an overall perspective view illustrating the sleeve and the guide member disposed in the intake port of the engine shown in FIG. 1. FIG. 4 is a cross-sectional view of the intake port taken along a plane parallel to the guide member. In FIGS. 3 and 4, as shown with arrows, a direction D1 is the direction of the intake downstream side of an intake port and a direction D2 indicates the direction of the intake upstream side of the intake port.

As shown in FIG. 1, an engine 100 of this embodiment includes a cylinder head 10 having an intake port 11 and an exhaust port 12, and a cylinder block (not shown) to the top of which the cylinder head 10 is assembled. Although it is not shown in the drawings, it is well-known that the cylinder block has a cylinder bore composed of a cylindrical space in which a piston is disposed. The cylinder bore is configured according to the number of cylinders formed in the cylinder block. In addition, on a crankcase disposed below the cylinder block, a crankshaft to which a piston is connected via a connecting rod is rotatably supported.

A ceiling part of the combustion chamber 20 is formed on the lower surface of the cylinder head 10 opposite to the cylinder bore. The ceiling part is formed as a so-called pent roof type in a gable roof shape. At the ceiling part of the cylinder head 10, an ignition plug (not shown) is disposed to face the combustion chamber 20.

The intake port 11 is a hole formed in the cylinder head 10 for feeding intake air from an intake manifold 23 to the combustion chamber 20. In the cylinder head 10, the intake port 11 extends in a direction inclined with respect to an axis X of the cylindrical space constituting the cylinder bore (not shown).

On an end surface 10a of the cylinder head 10 facing the intake manifold 23, as shown in FIG. 2, an upstream side opening 11a of the intake port 11 is formed. The shape of the upstream side opening 11a is formed so as to correspond to the shape of an opening on the intake downstream side of an intake passage 24 of the intake manifold 23 (see FIG. 1). The shape of the upstream side opening 11a of this embodiment is a laterally elongated substantially rectangular shape with rounded corners. The end surface 10a of the cylinder head 10 constitutes a mating surface S with the intake manifold 23 (the intake passage 24 of the intake manifold 23).

The intake port 11 is divided into a plurality (in this embodiment, two) branch passages 14 from the intake upstream side toward the intake downstream side (from the front side to the inner side of FIG. 2 when viewed on a paper surface and from the right side to the left side of FIG. 4), with a branch part 13 as the boundary. The shape of each of the two downstream side openings 11b of the respective branch passages 14 facing the combustion chamber 20 is circular.

As shown in FIGS. 2 and 4, groove parts 15 are respectively formed on opposing sidewall surfaces in the intake port 11. The groove part 15 serves for receiving a ridge part 31 of a sleeve 30 to be described later and supporting the sleeve 30 on an inner peripheral surface 11c of the intake port 11. As shown in FIGS. 2 and 4, the groove part 15 is formed from the end surface 10a of the cylinder head 10 having the upstream side opening 11a of the intake port 11 to a middle portion in the length direction toward the direction of the downstream side opening 11b of the intake port 11 (the direction D1 in FIG. 4). Although the cross-sectional shape of the groove part 15 of this embodiment is a semicircular shape, other shapes such as a semi-elliptical shape, a polygonal shape etc., can also be adopted.

While FIG. 1 only shows a portion of the exhaust port 12 shows close to the combustion chamber 20, but the exhaust port 12 is formed substantially the same as the intake port 11. Specifically, the exhaust port 12 has a pair of circular upstream side openings facing the combustion chamber 20. Also, although not shown, the shape of the downstream side opening (not shown) of the exhaust port 12, like the shape of the upstream side opening 11a of the intake port 11, has a laterally elongated substantially rectangular shape with rounded corners, so as to correspond to the shape of the opening of the exhaust upstream side of an exhaust manifold (not shown). However, the exhaust port 12 is not limited to such a configuration, and can be an exhaust manifold head port (head-integrated exhaust manifold) collected in the cylinder head.

As shown in FIG. 1, an intake valve 21 for opening and closing the intake port 11 is disposed in the intake port 11. As shown in FIGS. 2 and 4, the intake valve 21 is disposed in each of the pair of downstream side openings 11b, so as to be able to open and close the downstream side opening 11b of each of the branch passages 14. In the exhaust port 12, an exhaust valve 22 for opening and closing the exhaust port 12 is disposed. While not shown in the drawings, the exhaust valve 22, like the intake valve 21, is also disposed in each of the pair of upstream side openings (not shown). The intake valve 21 and the exhaust valve 22 are driven to open and close at a predetermined timing by a valve operating mechanism having a cam shaft and a rocker arm (not shown).

Next, the intake port structure of the engine 100 will be further described.

In the intake port 11, the sleeve 30 and a guide member 40 are provided. Here, details of the sleeve 30 will be described first with reference to FIGS. 1 to 4.

The sleeve 30 supports the guide member 40 at a predetermined position in the intake port 11 so as not to directly contact the inner wall surface of the intake port 11, and the sleeve 30 is an insulating member so that the heat from the inner peripheral surface 11c of the intake port 11 is not directly transferred to the guide member 40. The sleeve 30 of this embodiment is formed by a cylindrical body having an external shape substantially the same as the shape of the inner peripheral surface 11c of the intake port 11 (the shape of the inner surface shape of the material of the cylinder head 10). Specifically, as shown in FIGS. 2 and 3, the sleeve 30 is configured as a substantially rectangular cylindrical body having a laterally elongated substantially rectangular opening with rounded corners.

As shown in FIGS. 2 and 4, the ridge part 31 extending in the length direction of the sleeve 30 is integrally formed on the outer surface of each of the two sidewall parts 30c of the sleeve 30 so as to protrude toward the outer side. The cross-sectional shape of the ridge part 31 is substantially equal to the cross-sectional shape of the groove part 15 of the intake port 11. Also, the length of the ridge part 31 is approximately equal to the length of the groove part 15. Therefore, by inserting the sleeve 30 from the upstream side opening 11a of the intake port 11 toward the downstream side openings 11b, the pair of ridge parts 31 are respectively fit into the groove parts 15 to guide the insertion of the sleeve 30 and support the sleeve 30 at a predetermined position in the intake port 11.

As shown in FIG. 1 and FIG. 4, in a state in which the sleeve 30 is supported at a predetermined position, the upstream side end surface 30a of the sleeve 30 is disposed to be substantially flush with the end surface 10a of the cylinder head 10 on the inner peripheral side of the upstream side opening 11a of the intake port 11. A downstream side end surface 30b of the sleeve 30 is disposed at a position in a predetermined distance from the downstream side opening 11b of the intake port 11 toward the intake upstream side.

For thermal insulation, the sleeve 30 is formed of a material having a thermal conductivity lower than the material of the cylinder head 10. While there is no particular limitation on the exact material as long as the material is easy to mold and has thermal resistance, synthetic resins are generally used. Among the synthetic resins, polyphenylene sulfide (PPS) is most desirable. Further details concerning the sleeve 30 and the intake port 11 into which the sleeve 30 is inserted will be described later.

Next, the guide member 40 will be described.

The guide member 40 is a single plate member formed by metal such as an aluminum alloy. Both side edges of the guide member 40 in the width direction are embedded in both of the sidewall parts 30c of the sleeve 30 that have the ridge parts 31. As a result, the guide member 40 is supported in the sleeve 30 so as to divide the space inside the sleeve 30 into upper and lower halves. The guide member 40 of this embodiment is integrally molded during molding of the sleeve 30 made of a synthetic resin.

The guide member 40 partitions the passage in the intake port 11 passing through the inside of the sleeve 30 into an upper side passage P1 and a lower side passage P2, and guides the flow of the intake air from the side of the intake manifold 23 in a predetermined direction of the combustion chamber 20. When a tumble control valve 25 (see FIG. 1) provided in the intake passage 24 in the intake manifold 23 is closed, the guide member 40 of this embodiment limits the passage of the intake air flowing from the intake passage 24 of the intake manifold 23 to the intake port 11 to the upper side passage P1, and functions as a tumble plate for forming a tumble (longitudinal vortex) in the combustion chamber 20.

As shown in FIG. 1, in the intake manifold 23 and from the tumble control valve 25 to the mating surface S with the cylinder head 10, a partition wall 26 partitioning the intake passage 24 on the intake downstream side with respect to the tumble control valve 25 into upper and lower parts is formed. By being butted against a rear end surface 40a (the end surface disposed on the intake upstream side of the intake port 11, see FIGS. 2 and 4) of the guide member 40 in the intake port 11, the partition wall 26 partitions the intake downstream side with respect to the tumble control valve 25 from the intake manifold 23 to the intake port 11 into upper and lower parts.

As shown in FIG. 4, the guide member 40 integrally has a supported part 41 and an extending part 42. The supported part 41 is the part embedded in and supported by the sleeve 30. The extending part 42 is a part that is disposed on the front end side of the supported part 41 and extends further toward the downstream side opening 11b of the intake port 11 with respect to the downstream side end surface 30b of the sleeve 30. In this embodiment, the length of the supported part 41 (the length along the D1-D2 direction) is set to be longer than the length of the extending part 42 (the length along the D1-D2 direction). In the guide member 40, when disposed in the intake port 11, the side disposed on the side of the combustion chamber 20 where the intake valve 21 is disposed is set as the front end.

As shown in FIGS. 3 and 4, the supported part 41 is supported by the sleeve 30 over the entire length of the sleeve 30. The rear end surface 40a of the guide member 40 is substantially flush with the upstream side end surface 30a of the sleeve 30. The front end surface of the partition wall 26 in the intake manifold 23 is butted against the rear end surface 40a.

In this embodiment, the guide member 40 has a uniform thickness when viewed in either the width direction or the length direction. The thickness of the guide member 40 is smaller than the thickness of the partition wall 26. Therefore, when the intake air flows from the intake passage 24 of the intake manifold 23 into the intake port 11, the guide member 40 does not obstruct the smooth flow of the intake air.

Since the extending part 42 is not embedded in the sleeve 30, the extending part 42 is formed to be slightly narrower than the supported part 41. As shown in FIG. 4, the width of the extending part 42 of the guide member 40 of this embodiment is set to be in substantially the same size as the inner diameter of the sleeve 30 in the width direction.

As shown in FIGS. 3 and 4, the extending part 42 is bifurcated in correspondence with the two branch passages 14 of the intake port 11 on the way toward the downstream side opening 11b of the intake port 11. That is, a pair of branch extending plates 43 respectively extending toward the two downstream side openings 11b are integrally provided on the front end side of the extending part 42. As shown in FIG. 4, a branch part accommodating groove 43a formed between the pair of branch extending plates 43 accommodates, so as to straddle, the branch part 13 provided on the intake downstream side of the intake port 11. Accordingly, the front end parts of the pair of branch extending plates 43 are respectively inserted into the respective branch passages 14 of the intake port 11. The pair of branch extending plates 43 have the same protruding lengths toward the downstream side openings 11b, and are inserted into the respective branch passages 14 in the same length.

The front end sides of the respective branch extending plates 43 are disposed as close as possible to the intake valves 21 provided at the respective downstream side openings 11b of the intake port 11. Specifically, as shown in FIG. 4, on the back side of an umbrella part 21a, the front end side of each of the branch extending plates 43 is disposed to be as close as possible to the extent of not contacting the umbrella part 21a of the intake valve 21.

On the front end surface of each of the branch extending plates 43, a notch part 44 is formed. The notch part 44 is formed by concavely curving a portion of the front end surface of the branch extending plate 43 toward the intake upstream side. The notch part 44 is disposed at a place in the shortest distance from the axis Y (see FIG. 1) of the intake valve 21 on a front end surface 40b (the front end surface of each of the branch extending plates 43) of the guide member 40. Specifically, the notch part 44 is concavely curved toward the intake upstream side, with a point on the front end surface 40b of the guide member 40 in the shortest distance from the axis Y of the intake valve 21 as the center.

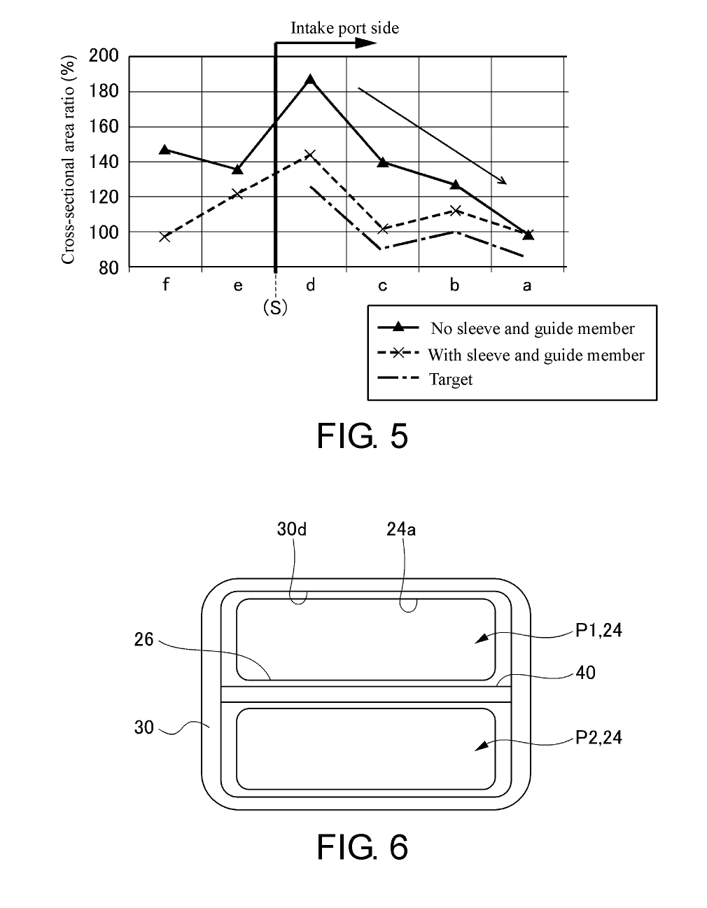

Even though each of the branch extending plates 43 of the guide member 40 is as close as possible to the back side of the umbrella part 21a of the intake valve 21, the notch part 44 is disposed to avoid interference with the back side of the umbrella part 21a. As shown in FIGS. 4 and 5, the notch part 44 of this embodiment is close to the extent of slightly accommodating the back side of the umbrella part 21a formed as a conical surface. However, between the guide member 40 and the intake valve 21, a clearance to the extent of having no interference when the intake valve 21 opens and closes is secured.

By being supported in the intake port 11 via the sleeve 30, the guide member 40 so configured functions to effectively form a tumble (longitudinal vortex) in the combustion chamber 20 when the intake air is limited to the upper side passage P1 by the tumble control valve 25. Since the guide member 40 can avoid the interference with the intake valve 21 by using the notch part 44 provided on the front end surface 40b, the guide member 40 can be arranged as close to the intake valve 21 as possible as compared with the conventional tumble plate. Therefore, according to the intake port structure including the guide member 40, stronger intake air guided by the guide member 40 can flow into the combustion chamber 20, and a tumble can be generated efficiently in the combustion chamber 20 to increase the tumble ratio.

There is no particular limitation on the exact shape of the notch part 44 of the guide member 40, as long as the notch part 44 can avoid the interference with the intake valve 21 while being as close to the intake valve 21 as possible. The notch part 44 of this embodiment is formed in a circular arc shape. According to the circular arc shaped notch part 44, a predetermined clearance to the extent that the front end surface 40b of the guide member 40 and the intake valve 21 do not interfere with each other can be easily secured between the front end surface 40b of the guide member 40 and the intake valve 21.

Such a circular arc shaped notch part 44 may have a circular arc shape centering on the axis Y of the intake valve 21. Since the distance between the notch part 44 and the intake valve 21 can be substantially equal on the inner peripheral surface of the notch part 44, the predetermined clearance to the extent that the front end surface 40b of the guide member 40 and the intake valve 21 do not interfere with each other can be easily secured between the front end surface 40b of the guide member 40 and the intake valve 21, and the guide member 40 can be further closer to the intake valve 21.

Next, the structures of the sleeve 30 and the intake port 11 will be further described. FIG. 5 is a graph showing a relationship between presence and absence of the sleeve at each position of the intake port and the cross-sectional area of the intake port.

The sleeve 30 is attached to a predetermined position in the intake port 11 by being inserted from the side of the downstream side surface 30b of the sleeve 30 with respect to the upstream side opening 11a of the intake port 11, as shown in FIG. 1.

Here, the cross-sectional area of the intake passage 24, through which the intake air flows toward the cylinder head 10, on the upstream side in the vicinity of the mating surface S between the intake passage 24 of the intake manifold 23 and the cylinder head 10 is defined as a “mating surface upstream area”, the intake port cross-sectional area, which excludes the sleeve 30 of the intake port 11, (the cross-sectional area of the intake port 11 resulting from the material of the cylinder head 10) on the downstream side in the vicinity of the mating surface S between the cylinder head 10 and the intake passage 24 is defined as a “mating surface downstream area”. The cross-sectional areas are areas of planes perpendicular to the axial direction (D1-D2 direction, the length direction of the guide member 40) of the intake passage 24 and the intake port 11.

In this case, as indicated by the solid line in FIG. 5, the intake port 11 has the “mating surface downstream area” (e.g., the cross-sectional area of a position d shown in FIGS. 1 and 5) greater than the “mating surface upstream area” (e.g., the cross-sectional area of a position e shown in FIGS. 1 and 5), and the intake port cross-sectional areas (the cross-sectional areas of positions b, c, d shown in FIG. 1 and FIG. 5) of the places where the sleeve 30 is disposed in the intake port 11 have a configuration of being gradually reduced from the mating surface S toward the side of the combustion chamber 20.

In this way, since the cross-sectional shape of the intake port 11 excluding the sleeve 30, namely the cross-sectional shape of the intake port 11 resulting from the material of the cylinder head 10, is a cross-sectional shape gradually reduced from the mating surface S toward the side of the combustion chamber 20, the sleeve 30 can be easily assembled into the intake port 11. In this case, the outer shape of the sleeve 30 fits the cross-sectional shape of the intake port 11 and is a shape that is reduced in diameter from the mating surface S toward the side of the combustion chamber 20. Although the cross-sectional shape of the intake port 11 excluding the sleeve 30 is not necessarily the cross-sectional shape that allows the intake air to flow in ideally, with the inner surface shape which the sleeve 30 has, the cross sectional shape of the intake port 11 resulting from an inner peripheral surface 30d of the sleeve 30 can be easily configured into a desired cross-sectional shape having a cross-sectional area which is increased and reduced along the axial direction of the intake port 11, as indicated by the broken line in FIG. 5. In this embodiment, the cross-sectional shape of the intake port 11 having the increased and reduced cross-sectional area of the inner peripheral surface of the sleeve 30 is constructed by using the shape of the inner peripheral surface of the wall surface disposed to be parallel to the guide member 40 in the sleeve 30.

The cross-sectional area of the inner peripheral surface 30d of the sleeve 30 may be equal to or greater than the cross-sectional area of the intake passage 24 of the intake manifold 23. That is, as indicated by the broken line in FIG. 5, the cross-sectional area of the intake port 11 having the sleeve 30 (the cross-sectional area of the inner peripheral surface 30d of the sleeve 30) is equal to or greater than the cross-sectional area at the minimum position of the intake passage 24 (the cross-sectional area of a position f shown in FIGS. 1 and 5). Accordingly, the sleeve 30 in the intake port 11 does not limit the intake air flowing into the intake port 11 from the intake passage 24 via the mating surface S. Therefore, the sleeve 30 does not result in a pressure loss of the intake air, and can allow the intake air from the intake passage 24 to flow into the combustion chamber 20 smoothly.

Also, regarding the intake port cross-sectional area at the place where the sleeve 30 is provided in the intake port 11 (the cross-sectional area of the intake port 11 resulting from the material of the cylinder head 10), the amount of gradual reduction from the side of the mating surface S to a predetermined position may be greater than the amount of gradual reduction from the predetermined position to the side of the combustion chamber 20. The predetermined position is an arbitrary position in the axial direction of the intake port 11 at the place where the sleeve 30 is provided.

For example, assuming that a position c shown in FIGS. 1 and 5 is the predetermined position, the slope toward the lower right of the solid line graph in FIG. 5 showing the amount of gradual reduction from the mating surface S to the position c is greater (steeper) than the slope toward the lower right of the solid line graph in FIG. 5 showing the amount of gradual reduction from the position c to the side of the combustion chamber 20. In other words, the middle portion of the inner surface shape of the intake port 11 excluding the sleeve 30 has a part in which the degree of diameter reduction partially changes. As shown in FIG. 1, the part is a step 11d where the inner diameter of the intake port 11 resulting from the material of the cylinder head 10 changes drastically. Therefore, when inserting the sleeve 30 from the side of the mating surface S with respect to the intake port 11, the sleeve 30 in the D1 direction (the inserting direction) of the intake port 11 can be easily positioned at the step 11d.

FIG. 6 is a diagram showing a relationship between the sleeve 30 as well as the guide member 40 and the intake passage 24 when the mating surface S between the intake port 11 having the sleeve 30 and the intake passage 24 is viewed from the side of the intake port 11. In FIG. 6, the illustration of the tumble control valve 25 in the intake passage 24 of the intake manifold 23 is omitted.

As shown in FIG. 6, on the mating surface S, the position of the inner peripheral surface 30d of the sleeve 30 may be arranged on an outer side in the radial direction with respect to the position of an inner peripheral surface 24a of the intake passage 24. That is, any position on the inner peripheral surface 30d of the sleeve 30 is commonly located on an outer side in the radial direction (the radial direction of the intake port 11 and the intake passage 24) when compared with the position of the inner peripheral surface 24a of the intake passage 24.

In this way, the sleeve 30 in the intake port 11 does not limit the intake air flowing into the intake port 11 from the intake passage 24 via the mating surface S and does not result in a pressure loss of the intake air, and the sleeve 30 can be certainly positioned in the intake port 11. That is, since the upstream side end surface 30a of the sleeve 30 abuts against the end surface of the intake manifold 23 in the vicinity of the intake passage 24 at the mating surface S, the movement of the sleeve 30 toward the side of the intake manifold 23 (the direction D2) is limited, and the sleeve 30 is positioned. Since the difference in position between the inner peripheral surface 30d of the sleeve 30 and the inner peripheral surface 24a of the intake passage 24 can serve as a margin for assembling variation of the sleeve 30, the sleeve 30 can be prevented from protruding inwardly in the radial direction with respect to the position of the inner peripheral surface 24a of the intake passage 24 even if the assembling variation occurs when the sleeve 30 is assembled into the intake port 11.

What is claimed is:

1. An intake port structure, which has, in an intake port of a cylinder head of an engine, a sleeve that is disposed along an inner peripheral surface of the intake port and made of a material having a thermal conductivity lower than a material of the cylinder head,
wherein when a cross-sectional area of an intake passage, through which intake air flows toward the cylinder head, on an upstream side in an vicinity of a mating surface between the cylinder head and the intake passage is defined as a mating surface upstream area, and an intake port cross-sectional area of the intake port, which excludes the sleeve, on a downstream side in the vicinity of the mating surface between the cylinder head and the intake passage is defined as a mating surface downstream area,
the mating surface downstream area is greater than the mating surface upstream area, and the intake port cross-sectional area at a place where the sleeve is disposed in the intake port is gradually reduced from the mating surface toward a combustion chamber side.

2. The intake port structure according to claim 1, wherein a cross-sectional area of an inner peripheral surface of the sleeve is equal to or greater than the cross-sectional area of the intake passage.

3. The intake port structure according to claim 1, wherein the intake port cross-sectional area at the place where the sleeve is provided in the intake port has an amount of gradual reduction from the mating surface side to a predetermined position greater than an amount of gradual reduction from the predetermined position to the combustion chamber side.

4. The intake port structure according to claim 1, wherein on the mating surface, a position of the inner peripheral surface of the sleeve is disposed on an outer side with respect to a position of an inner peripheral surface of the intake passage in a radial direction.

5. The intake port structure according to claim 2, wherein the intake port cross-sectional area at the place where the sleeve is provided in the intake port has an amount of gradual reduction from the mating surface side to a predetermined position greater than an amount of gradual reduction from the predetermined position to the combustion chamber side.

6. The intake port structure according to claim 2, wherein on the mating surface, a position of the inner peripheral surface of the sleeve is disposed on an outer side with respect to a position of an inner peripheral surface of the intake passage in a radial direction.

7. The intake port structure according to claim 3, wherein on the mating surface, a position of the inner peripheral surface of the sleeve is disposed on an outer side with respect to a position of an inner peripheral surface of the intake passage in a radial direction.

8. The intake port structure according to claim 5, wherein on the mating surface, a position of the inner peripheral surface of the sleeve is disposed on an outer side with respect to a position of an inner peripheral surface of the intake passage in a radial direction.
